(19) United States
(12) Patent Application Publication
(10) Pub. No.: US 2013/0135871 A1
(43) Pub. Date: May 30, 2013

(54) Multi-Purpose LED Lighting and Mirror Accessory for Use with Mobile Phone Devices

(71) Applicant: Hooshmand Harooni, Los Angeles, CA (US)

(72) Inventor: Hooshmand Harooni, Los Angeles, CA (US)

(21) Appl. No.: 13/308,467

(22) Filed: Nov. 30, 2011

(51) Int. Cl. F21V 5/04; F21V 9/00; F21V 13/04

(52) U.S. Cl. 362/268

(57) ABSTRACT

This invention describes a Multi-Purpose LED Lighting And Mirror Accessory to be used with mobile phone devices, for both a cosmetic purpose as well as a photographic and videographic apparatus enhancement. (hereinafter known as “Multi-Purpose LED Lighting And Mirror Accessory”).

More specifically, the Multi-Purpose LED Lighting and Mirror Accessory provides a had plastic protective case to a mobile phone device that integrates a mirror on the exterior surface of the case to be utilized for cosmetic purposes and a mechanism to mount a series of lenses, filters, or treatments on the inside surface of the protective case so as to provide varying illumination characteristics to the LED light source that is provided natively with the mobile phone device. These mounted attachments can be utilized in conjunction with the mirror for cosmetic purposes, and also to provide different lighting while utilizing the built-in LED for still or motion photography.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### SUMMARY OF THE INVENTION

In view of the foregoing, this patent application provides for a Multi-Purpose LED Lighting and Mirror Accessory for mobile phone devices that allows the users to change the properties of the LED light. source natively attached to the mobile phone device. This modification of the illumination characteristics of the LED light source is provided by a mechanism to position and hold in place a set of different lenses, filters, or treatments directly over the LED light source without obscuring the field of the vision of the camera. The mechanism holding the lenses, filters, or treatments is in turn integrated into the protective case for the mobile phone device to allow exact positioning of each item. It is this unique combination of small lens (or filter or treatment) placement combined with the protective case that is the essence of the invention claimed in this patent.

A specific embodiment is described in this document that integrates the lenses, filters, or treatments into the protective case by mounting said items on a rotary dial that is in turn attached to the interior of the protective case. The rotary dial contains multiple lenses, filters, or treatments each of which can be placed in front of the LED lighting source to provide a different illumination effect. The shape of the lenses, filters, or treatments will be shaped such that they match and completely overlap the LED lighting source of the mobile phone device, and in most cases will be of a round, circular shape. Any number of lenses, filters, or treatments could be mounted on the rotary dial—the most practical would be to symmetrically place either 4 or 6 individual lenses, filters, or treatments on rotary, however, each application of this invention could utilize a differing number of lenses for a wide variety of illumination characteristics that could be taken advantage of when taking still or motion photography using the mobile phone device's built-in camera. This application provides an example below of one such potential combination of six lenses, where each of the lenses would have the properties and the result described:
(a) No lens—provides an open hole in place of a lens to allow the user to utilize the built in capabilities of the LED light source and camera built into the mobile phone device.
(b) Fresnel lens—provides for a lens with concentric curves etched into its surface to provide a diffusion effect onto the LED light source.
(c) Milky White Fresnel lens—provides for a diffused white light effect,
(d) Double Milky White Fresnel lens—provides for a more diffused light over that of (c).
(e) Red clear lens—provides for a contrast filter when used with black and white photography or video.
(f) Orange clear lens—provides for nighttime color enhancement.

In this six lens example, it is clear the different lenses provide for a multitude of effects in an easy to use manner integrated with a protective case that would be highly recommended to be used with the mobile phone device by the manufacturer already, thereby adding a significant benefit without adding additional parts or items that need to be carried with the phone device. It is easy to see how this complement of lenses, filters, or treatments helps to turn a simple camera and lighting source from a mobile phone device into an enhanced, professional photography and videography recording device.

In yet another variation to the Multi-Purpose LED Lighting and Mirror Accessory invention, a mirror can be attached to the exterior surface of the protective case. In this instance the mirror would be mounted on the same side of the protective case as that side containing the LED lighting source. Then, by positioning the milky white Fresnel lens described in the example above in front of the LED light source, a sufficiently softened and diffused light source is emitted from that surface of the mobile phone device such that there is enough light from the LED light to be able to clearly view one's own self-image in the mirror, yet not being blinded by the LED light source itself. With the milky white Fresnel lens, for example, it will be possible to look directly into the LED light source without any loss of visual acuity. In this application, therefore, the invention described in this document serves very well as a lighted makeup application mirror.

It is significant to note that in the rotary dial assembly structure in the described embodiment, that each lenses, filter, or treatment is placed completely over the LED light source, as it is important to not allow any ambient light to bleed from around the edges of the lens. In this fashion the diffusion effect is applied evenly on the entire LED light source. Further, it is the nature of mobile phone devices that they are carried in pockets, in purses, carrying holsters, and in general in a manner where it is moved or shaken substantially between periods of active use. In this rotary dial embodiment, the lens, filter, or treatment will be allowed to be locked into position over the LED light source either through a friction gear assembly or by a notch in the dial assembly that locks each lens, filter, or treatment into place as the dial is turned.

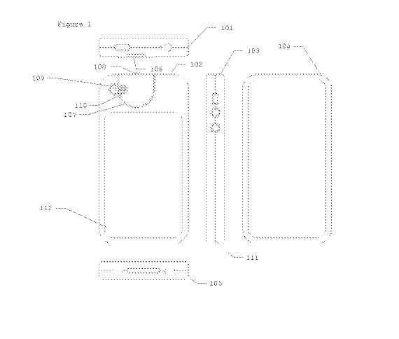

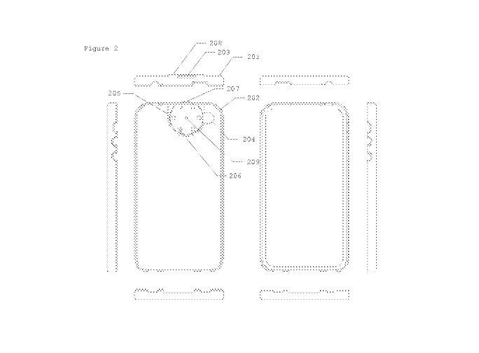

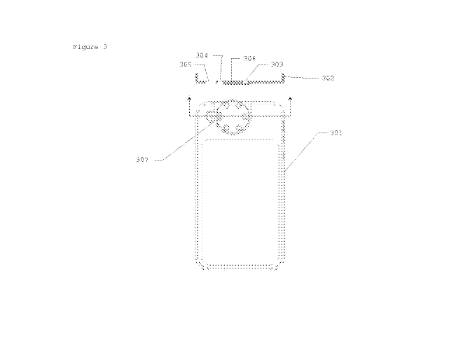

### BRIEF DESCRIPTION OF THE DRAWINGS

<FIG. 1> A diagram depicting all sides of the Multi-Purpose LED Lighting and Mirror Accessory in its closed form and attached to a mobile phone device.

<FIG. 2> A diagram depicting an exploded view of the Multi-Purpose LED Lighting and Mirror Accessory shown from the inside of the protective case.

<FIG. 3> A diagram depicting a cross section of that portion of the Multi-Purpose LED Lighting and Mirror Accessory through the portion of the rotary dial and lenses assembly that cuts through the center of the camera.

### DETAILED DESCRIPTION OF THE INVENTION

The Multi-Purpose LED Lighting and Mirror Accessory described in this application therefore provides a unique combination of lighting enhancements integrated wish a mirror accessory all contained in a small, form factor protective case for the mobile phone device. The outside surface of the Multi-Purpose LED Lighting and Mirror Accessory's protective, case element would be manufactured. most often of a strong polycarbonate plastic casing of any color, with the all exterior surface being rubberized to allow for maximum protection against damage when the unit is dropped.

<FIG. 1> shows the Multi-Purpose LED Lighting and Mirror Accesory in its closed form, attached to a mobile phone devices as a protective case. The following views are show—101 depicts a top view, 102 depicts a back view, 103 depicts a side view, 104 depicts a front view, and 105 depicts a bottom view. Note that the protective case is manufactured in two pieces, front and back, and are snapped together along a junction point shown as 111 in side view 103.

In <FIG. 1> 101, the top view of the invention, 106 depicts the top of the rotary dial assembly protruding slightly from the top edge of the Multi-Purpose LED Lighting and Mirror Accessory. Users will be able to turn the rotary dial to select different lenses, filters, or treatments by turning the rotary dial at point 106, and the edges of the rotary dial itself are geared to provide tactile feedback when turned.

In <FIG. 1> 102, the back view of the invention, several details are shown. 107 shows the slight exterior protusion from the protective case where the rotary dial is mounted. 109 shows the mobile phone device's camera, and it can be seen clearly that the rotary dial covers the native LED light source at 110 but not the camera at 109. 108 shows a small portion of she rotary dial protruding from the sop surface of the protective case. Finally, the integrated mirror is shown in 112.

<FIG. 1> 103, again, shows the side view of the protective case, and 105 shows the bottom view.

<FIG. 1> 104 shows the front view of the Multi-Purpose LED Lighting and Mirror Accessory device, in particular showing that there is only a very small portion. of the protective case that covers the front of the mobile. phone device so as to minimize obscurity of any native mobile phone features.

<FIG. 2> shows an exploded view of the Multi-Purpose LED Lighting and Mirror Accessory device, exploded from the inside of the protective case outwards. In the top portion of the exploded view 201, 203 depicts the small opening for the rotary dial that is turned by the user, and 208 shows the small protrusion housing the rotary wheel assembly. <FIG. 2> 202 shows a detailed exploded view of the interior of the protective case. 204 shows the opening for the mobile phone device camera, and it can be seen, again, that the rotary dial does not obscure the camera. 205 depicts the rotary dial with multiple embedded lenses, filters, or treatments shown in 206, with rotary dial mounted into the housing along a central axis 209.

<FIG. 3> shows a cross section view of the Multi-Purpose LED Lighting and Mirror Accessory, cut across through the center of the rotary dial. 301 is the normal interior view, and 302 shows the cross section at the aforementioned point. 303 depicts a lenses that is not currently on top of the LED light source of the mobile phone device, 306 depicts the rotary dial, 304 snows the active lens, filter, or treatment that is currently in use and is in front of the LED light source, and 305 shows the camera opening.

What is claimed is:

1: A unique multi-purpose protective case for a mobile phone device that integrates a series of small lenses, filters, or treatments mounted within the protective case assembly such that each lens, filter, or treatment can be selectively placed in front of the LED light source of the mobile phone device. Further claimed that as different lenses, filters, or treatments are placed directly in front of the LED light source, the illumination characteristics of said light source are enhanced or modified.

2: In a specific embodiment to the Multi-Purpose LED and Mirror Accessory according to claim 1, the small lenses, filters, or treatments are placed on a rotary dial such that the dial can be turned to allow each lens, filter, or treatment to be selectively placed directly in front of the LED light source of the mobile phone device. The series of small lenses, filters, or treatments mounted on said rotary dial are positioned on the inside surface of the protective case and as it is turned, the rotary dial allows the user to place different lenses, filters, or treatments directly in front of the native LED light source to change the illumination characteristics thereof. The varying illumination characteristics provide for different lighting effects when users utilize the native camera built into the mobile phone device for photography or videography purposes.

3: A specific embodiment of the Multi-Purpose LED Lighting and Mirror Accessory in claim 1, with a mirror attached and positioned on the exterior of the protective case next to the rotary dial. With a specific lens, filter, or treatment on the rotary dial placed directly over the LED light source, the light will be diffused sufficiently to reflect a self--image from the mirror without projecting a blinding illumination to the user.

4: In a specific embodiment of the Multi-Purpose LED Lighting and Mirror Accessory according to claim 2, the lenses, filters, or treatments mounted on the integrated rotary dials are distinct, circularly shaped lenses, filters, or treatments that can be moved to a position directly in front of the native LED light source on the phone as the dial is turned such that the lens, filter, or treatment covers any LED lighting source (s) in its (their) entirety while not obscuring the camera or video view in any manner. Each lens, filter, or treatment has a black coating on the edge surface to prevent light seepage to occur when the lens, filter, or treatment is placed on top of a LED lighting source. Each lens, filter, or treatment will provide a varying amount of diffusion, softening, and color to the LED light source's illumination.

5: In the Multi-Purpose LED Lighting and Mirror Accessory according to claim 1, the rotary dial allows the user to place each individual lenses, filters, or treatments directly and over the central longitudinal axis of the LED light source in a manner such that the rotary dial does not move as the mobile phone device is handled by the user, but rather, requires a distinctive and tactile movement of the rotary dial in order to move to the next lens, filter, or treatment in the sequence.
